(19) United States
(12) Patent Application Publication
(10) Pub. No.: US 2026/0065742 A1
(43) Pub. Date: Mar. 5, 2026

(54) System and Method of Monitoring Casino Gaming Activity

(71) Applicant: Tavolo Intellect LLC, Grosse Pointe, MI (US)

(72) Inventors: Ryan Patrick McClellan, Grosse Pointe, MI (US); Evan Andrew Juras, Bozeman, MT (US); Mark Bedair Wassef, Hoboken, NJ (US)

(21) Appl. No.: 19/318,991

(22) Filed: Sep. 4, 2025

Related U.S. Application Data
(60) Provisional application No. 63/690,415, filed on Sep. 4, 2024.

(51) Int. Cl. G07F 17/32

(52) U.S. Cl. CPC G07F 17/322; G07F 17/3232; G07F 17/3241

(57) ABSTRACT

A system and method for improving monitoring of a casino gaming table that includes capturing a camera image or video feed of a gaming table layout; identifying a calibration marker having a known geometric configuration positioned on the gaming table layout; generating a normalized, substantially top-down digital representation of the gaming table layout; applying a stored template representation of the gaming table layout onto the normalized, substantially top-down representation of the gaming table layout such that each of the pre-determined regions of interest is spatially aligned with corresponding locations in the normalized, substantially top-down representation of the gaming table layout; detecting presence of a gaming object within at least one of the predetermined regions of interest; correlating the detected gaming object with a stored template representation of the gaming object; and generating, gameplay data derived from the detected physical gaming object.

### CROSS REFERENCE TO RELATED APPLICATIONS

This application claims priority to U.S. 63/690,415 filed on Sep. 4, 2024, the entirety of which is hereby incorporated by reference herein for all purposes.

### FIELD

These teachings relate generally to a system and method for monitoring casino table games, and more specifically to a system and method for improving monitoring of casino gaming tables using image transformation, template-based object recognition, and analysis techniques.

### BACKGROUND

Casino table games such as blackjack, poker, and baccarat involve rapid placement and movement of wagering chips, playing cards, and currency, all of which must be monitored to ensure game integrity, compliance with regulations, and protection against fraud. Historically, such monitoring has been performed manually by surveillance staff observing video feeds. Manual monitoring, however, is error-prone and labor intensive.

Some computer-vision systems have been proposed to assist with the monitoring of casino table games. However, many systems and methods are inherently sensitive to camera angle, mounting position, and table orientation, leading to inaccuracies when conditions vary. Accordingly, improvement in the art is needed.

### SUMMARY

A system and method are disclosed for monitoring and analyzing activity at a casino gaming table. The system obtains an overhead and/or oblique camera image or video feed of a table game layout from one or more cameras. The obtained image or video feed may be an actual image or video feed, a raw image or video feed, an unaltered image or video feed, etc. This may mean that there are no changes, modifications, alterations that are made to the video and/or image feed obtained from the one or more cameras or video feeds. In other words, image or video clarity, sharpness, angles, colors, etc. may be unaltered.

When a camera captures an image or video feed of the actual gaming table from an overhead or oblique angle, the table surface and objects positioned thereon may appear distorted due to perspective projection. For example, straight lines may appear convergent, circular betting regions may appear elliptical, the relative spacing between objects may not reflect their true physical proportions, and playing card values or chip denominations may be difficult to discern (e.g., the numeral “4” may appear similar to the numeral “7”). To correct this, the system and method according to these teachings applies a geometric transformation that transforms and orients the pixels of the oblique image into a coordinate system corresponding to a substantially perpendicular, overhead, bird's-eye view. The geometric transformation may take place using a computer software, hardware, algorithm, machine learning, artificial intelligence, match matrix transformation, etc. For example, an OpenCV (Open Source Computer Vision Library) program may be used for the transformation and/or any of the matching or corresponding steps disclosed herein.

To transform an oblique camera image into a normalized representation, the disclosed system and method utilize one or more calibration markers positioned at known locations on the gaming surface. In certain embodiments, the calibration markers comprise predefined geometric patterns, such as QR codes, checkerboard patterns, or other fiducial markers having a known configuration, which enable the system to compute geometric transformations of the captured image with improved accuracy.

A processing device is configured to detect the calibration markers within the oblique camera image or video feed and to establish point correspondences between the observed marker locations and their known positions in an idealized top-down coordinate system. Based on these correspondences, the processing device generates a substantially perpendicular, normalized representation of the gaming table layout, also referred to as a bird's-eye view. A stored top-down template representation of the gaming table layout may then be applied onto the normalized representation, such that features of the template align with corresponding features in the transformed image.

The top-down template representation of the table game layout may define one or more regions of interest (ROIs). These ROIs are applied onto the normalized top-down representation of the table game layout such that each ROI corresponds to its actual physical location on the gaming table. In this manner, the system maintains accurate alignment of the ROIs regardless of camera orientation, perspective distortion, or lens characteristics.

Such a relationship—transforming a camera image of the table game layout to match a template representation of the table game layout, rather than transforming a template representation of the table game layout to match a camera image of the table gam layout, as some vision based systems require—provides a more stable and accurate basis for detecting gaming objects and interpreting game play.

The system and method according to these teachings then monitors or observes game play at the casino table. The monitoring, observing, and/or generating gameplay data may utilize various machine learning and deep learning techniques disclosed herein.

Advantageously, the disclosed system and method may be implemented using existing cameras and surveillance infrastructure already present at a gaming establishment. For example, many casinos employ overhead cameras positioned in ceilings to monitor gameplay, patrons, and employees. These existing cameras may be utilized by the disclosed system and method to efficiently monitor gaming activity in a manner that improves upon conventional solutions. In alternative embodiments, new or additional cameras or surveillance devices may be incorporated into the system. In such cases, a casino may elect to upgrade its surveillance systems to further enhance the accuracy of identifying, monitoring, and analyzing gameplay activity.

The system comprises one or more cameras positioned at oblique angles relative to one or more gaming tables. A processor is operatively coupled to the cameras and configured to receive camera images, execute a normalization process on the images, and apply one or more stored template overlays to the normalized images. The processor is further configured to analyze game play activity by monitoring activity within the normalized images. In certain embodiments, the processor utilizes the template overlays to match or compare detected physical items to stored representations of known items, thereby determining attributes of playing cards, currency, gaming chips, and other gaming objects. The processor may additionally apply predetermined gaming rules to interpret the monitored activity, such that the system identifies not merely that a $5.00 currency note was placed on the table, but that the $5.00 currency note corresponds to a buy-in action by a new player entering the game.

A system for monitoring a casino gaming table is disclosed, the system comprising: a camera arranged at an overhead oblique angle relative to a casino gaming table, the camera configured to capture an image or video feed of a gaming table layout on the casino gaming table that includes a calibration marker having a predetermined geometric configuration positioned on the gaming table layout; a processing device operatively coupled to the camera and configured to: generate a normalized, substantially top-down digital representation of the gaming table layout by geometrically transforming the captured image or video feed based on the calibration marker; apply a stored template representation of the gaming table layout that defines a plurality of predetermined regions of interest, such that the predetermined regions of interest are spatially aligned with corresponding locations in the normalized digital representation; detect presence of a physical gaming object within at least one of the predetermined regions of interest in the normalized digital representation; correlate the detected physical gaming object with a stored template representation of the gaming object; and generate gameplay data derived from the detected physical gaming object, the gameplay data including at least one of: a bet amount, identity of a playing card, a player position, or a payout determination. Gameplay data may refer to dealer speed, number of hands dealt per hour or shift, table utilization per hour or shift, number of errors made by the dealer or player, or any combination thereof.

The processing device is configured to: search a repository of stored template representations of a plurality of gaming object; identify a matching stored template representation of the gaming table layout from the stored repository of a plurality of stored template representations of gaming table layouts; and if it is determined that the camera image or video feed does not correspond to the stored template representation of the gaming table layout, performing at least one of: generate a warning or alert; and/or halt game play; and/or repeat the search.

The camera is part of a surveillance system and/or part of a table sign.

The calibration marker is an image that is placed onto the gaming table layout and then removed from the gaming table layout, where the calibration marker comprises a QR code or a checkerboard pattern.

The calibration marker is an image that is part of the gaming table layout and is not removed from the gaming table during game play.

### BRIEF DESCRIPTION OF THE FIGURES

FIG. 1 is a perspective view of a casino gaming table.

FIG. 2 illustrates an image or video feed from the surveillance system or camera shown displayed on a monitoring device or terminal.

FIG. 3 is a flow chart illustrating steps of the method according to these teachings.

FIG. 4 is a perspective view of a casino gaming table with a calibration marker placed on the gaming table layout.

FIG. 5 illustrates a converted or normalized, substantially top-down representation of the gaming table layout.

FIG. 6 illustrates a stored template representation of a gaming table layout that includes one or more template regions of interest.

FIG. 7 illustrates a stored template representation overlaid onto the converted or normalized, substantially top-down representation of the gaming table layout.

FIG. 8 illustrates feedback messages or acknowledgements generated and presented on a monitoring device or terminal based on the observations or analysis made by the processing device.

FIG. 9 illustrates a plurality of table layout images on a display device where their orientations differ.

FIG. 10 illustrates a plurality of table layout images on a display device where their orientations are aligned.

FIG. 11 illustrates a camera, a reflective surface or mirror, and the view of the reflected, refracted, or redirected view.

FIG. 12 illustrates a placard.

### DETAILED DESCRIPTION

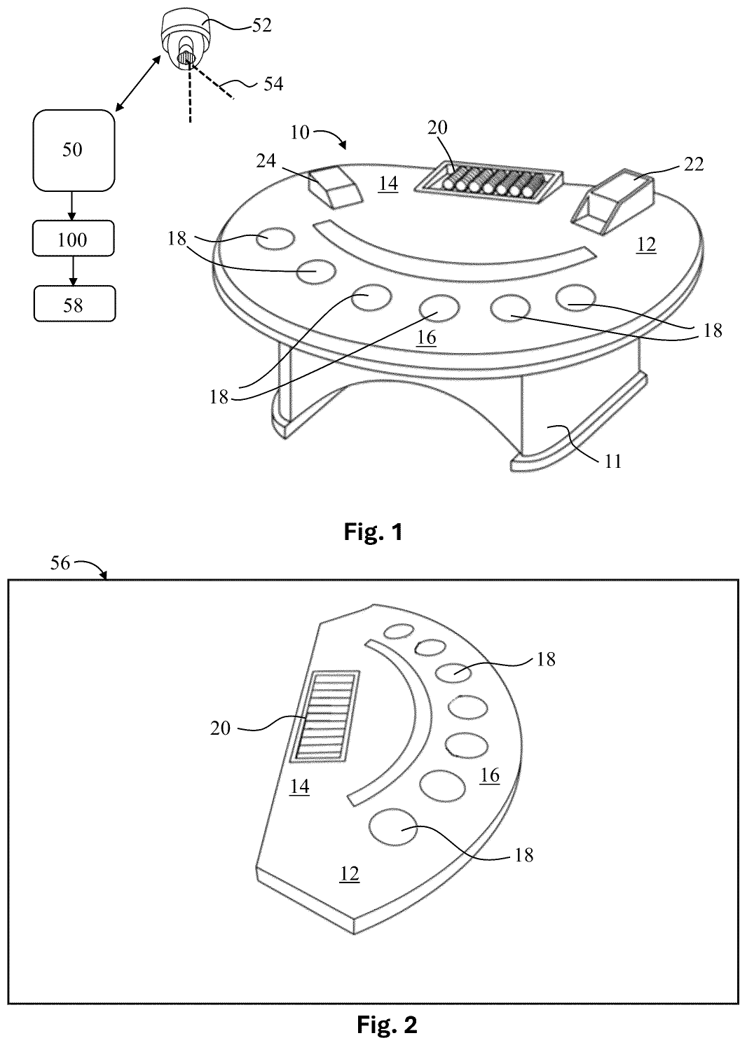

FIG. 1 illustrates an exemplary casino gaming table 10. The gaming table 10 may be provided in or associated with a facility such as, for example, a casino, hotel, cruise ship, or other entertainment venue. A casino game may be conducted or played at or upon the gaming table 10. In some embodiments, the casino game may comprise a card game, such as blackjack, although other games of chance or skill such as poker and baccarat may likewise be played at the gaming table 10 without departing from the scope of the present disclosure.

The gaming table 10 may comprise a gaming table layout 12. The gaming table layout 12 may be on a base 11 of the table 10. The gaming table layout 12 may be a felt or material surface on which a dealer area 14 and a player area 16 are defined. In some embodiments, the dealer area 14 is positioned along a rear portion of the table 10 or layout 12 and is configured to accommodate a dealer or house representative, while the player area 16 is positioned along a front portion of the table 10 or layout 12 and is configured to accommodate one or more players. The gaming table 10, and in particular the gaming table layout 12, may include one or more regions of interest.

A region of interest (ROI) may comprise a designated portion of the gaming table layout 12. In various embodiments, a ROI may correspond to an area of the gaming table layout 12 in which one or more players and/or the dealer interact during gameplay, or to an area where one or more gaming items are or are expected to be located during gameplay. By way of example, an ROI may include one or more betting regions 18 (e.g., main bet, side bet, or progressive wager areas), a chip tray 20 configured to hold gaming chips, a card shoe 22 configured to contain undealt playing cards, a discard tray or rack 24 configured to receive used playing cards, a dealer area 14 in which the dealer may deal cards, reveal cards, and/or accept currency for a buy-in, a player area 16 in which one or more cards may be dealt to players or in which players may place wagers, or any combination thereof.

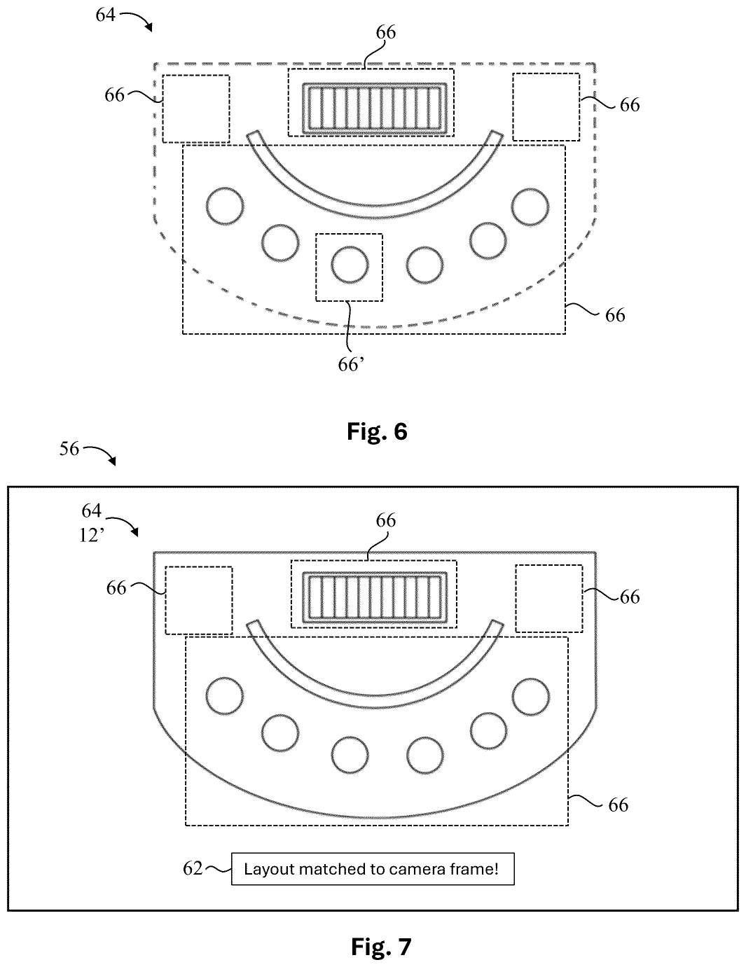

A region of interest (ROI) may be located within another regions of interest (ROI). For example, referring to FIG. 6, a secondary region of interest 66′ may be located within a larger region of interest 66. This may allow the system and method to monitor region 66 for gaming activity, and also specifically region of interest 66′ for chip or bet placement. Such additional regions of interest 66′ may be located within any of the other regions of interest 66 on the gaming table. For example, the entire template representation may include a region of interest 66 and other areas of the template may include secondary regions of interest 66′. In some embodiments, secondary regions of interest 66′ may allow the system and method to look for certain detailed gaming images or items, such as value or suit of playing cards, value or denomination of gaming chips, etc., while the larger region of interest 66 may simply look for a general gaming item or gaming activity taking place on the gaming table.

A gaming item or item of interest may comprise one or more objects associated with gameplay or activity at the gaming table. In certain embodiments, a gaming item may include gaming chips, playing cards, cash or other forms of currency, tickets such as ticket-in/ticket-out (TITO) tickets, player loyalty cards, vouchers, coupons, dice, beverage containers, ashtrays, or any combination thereof.

The gaming facility or venue in which the gaming table 10 is located and/or where the system and method according to these teachings is deployed may include one or more surveillance systems 50. A surveillance system 50 may comprise one or more surveillance monitoring devices or cameras 52. A camera 52 may be configured to capture still images or live video feeds of gaming activity occurring within the gaming environment, the gaming table 10, or on the table game layout 12. As used herein, the term surveillance system may refer to any arrangement of hardware, software, or a combination thereof that is configured to monitor, record, or analyze activity at one or more casino gaming tables. A surveillance system may include, without limitation, cameras, processors, analysis devices, detection devices, databases, monitoring displays, operator terminals, and communication networks. The captured still images and/or video feed from the one or more cameras 52 may be displayed on a monitor or screen in real time, stored for later use or review, or both. Storage may be implemented in a memory associated with a physical drive located on-site at the facility, in a remote off-site location, in a cloud-based storage environment, or in any combination thereof.

The system and method 100 according to these teachings may utilize an image or video feed one or more of the surveillance cameras 52. However, an image or video feed from one or more cameras that is/are not part of a surveillance system may be utilized in the method and system disclosed herein. Such non-surveillance cameras (referred to herein generally as camera 52) may be part of a vision-system that is incorporated into or attached to a table sign, an elevated lollipop sign, a camera attached to the chip tray, card shoe, table, table layout, etc.

One or more of the cameras 52 (surveillance and/or non-surveillance cameras) may be on a closed network or server. Security personnel, casino personnel, or other authorized individuals responsible for ensuring the integrity of gaming and overall security within the facility may have access to an output from the cameras 52. Through such access, the authorized personnel may observe casino activity, player activity, and/or dealer or other casino staff activity in real time (i.e., live) or with a slight delay (e.g., a few seconds or minutes). In addition, the cameras 52 may be utilized to review or replay previously captured gaming activity. Such activity may be retrieved from storage for analysis over various time frames, such as within the past hour, day, week, or longer, depending upon system configuration and retention policies. In some embodiments, the surveillance system may further enable flagged event review, automated alerts, or enhanced playback tools (e.g., slow motion, zoom, or time-stamped indexing) to assist personnel in evaluating gaming events or potential irregularities.

To clarify, casino activity may include but is not limited to player activity, casino personnel activity, card value and/or card placement, chip value and/or chip placement, or any combination thereof. Player activity may include but is not limited to a player entering a game, leaving a game, making a bet, making or providing one or more hand signals or gestures to casino personnel (hit, stay, double down, split, etc.), etc. Casino personnel activity may include but is not limited to dealing cards, paying out, collecting bets, collecting money, distributing or collecting chips, shuffling cards, starting a game, ending a game, etc.

One or more of the cameras 52 may be positioned in an elevated location relative to a gaming table 10 or gaming table layout 12. For example, a cameras 52 may be mounted to, suspended from, or otherwise attached to a wall, ceiling, or other structure of the facility. In certain embodiments, a cameras 52 may be positioned overhead but at an angle or offset relative to a center of the gaming table 10 or gaming table layout 12, such that a line of sight or viewing angle or range 54 of the cameras 52 is inclined or skewed with respect to the gaming table layout 12. An example of such an overhead yet angled configuration of a camera 52 relative to the gaming table layout 12 is illustrated in FIG. 1.

Due of the overhead, oblique, and/or angled orientation or position of the one or more cameras 52 relative to the gaming table 10 or gaming table layout 12, still images and/or video feeds obtained therefrom may be at an oblique angle and/or exhibit distortion or skew. In particular, a captured image or video feed from such an overhead, slanted, and/or obliquely-oriented camera 52 may reflect an aggressive or harsh perspective angle, foreshortening, or other visual artifacts that can obscure details of the gaming table 10 or gaming table layout 12, such as the layout of wagering regions, card placement areas, chip positions, currency values, playing card values, etc. For example, circles may be presented as ellipses, rectangles may be presented as trapezoids, the number 4 may appear like the number 7, etc. Such distortions may complicate the ability of casino personnel, surveillance staff, or vision processing systems to effectively monitor, review, and analyze casino activity, player activation, and/or casino personnel activity.

For example, referring to FIG. 2, an image or video feed from the surveillance system 50 or camera 52 is shown displayed on a monitoring device or terminal 56. The monitoring device or terminal 56 may be a computer, screen, tablet, or other viewing or computer device that may be located within the gaming facility, such as in a closed or restricted surveillance room, a pit area, at the back of a table sign at the gaming table, or at a remote location away from the casino facility. In some embodiments, the image or video feed may be transmitted from the surveillance monitoring device 56 to the processing device 58 via a one-way, closed server, or private network connection. In some embodiments, the monitoring device or terminal, the surveillance system 50, the processing device, the analysis device, or any combination thereof may be located at a remote area such as the cloud, or in another location or facility such as a central processing station.

The image or video feed of the table game layout 12 obtained from the one or more cameras 52 is at an oblique or perspective angle due to the location of the overhead camera 52 relative to the table top 12 (see FIG. 1), which may make observation or monitoring of gaming activity more difficult for a human observer and/or a processing device of the system and method 100 disclosed herein. For example, shadows or poor lighting conditions may complicate or add to difficulties in observing or monitoring casino activity, the value or denomination of playing cards and gaming chips, etc. Such differing perspectives may result in inconsistent image orientations, which may further complicate human review and/or computer vision-based processing and analysis. This difficulty may be compounded when multiple images or video streams are monitored simultaneously, where each stream may originate from a different camera 52 oriented at a different angle or position relative to a respective gaming table 10 or gaming table layout 12.

While physically relocating the one or more overhead cameras 52 so as to be positioned directly above a gaming table 10 or gaming table layout 12 may be a potential option to obtain better top down or normal images or video, such an approach may be time-consuming, labor-intensive, and costly. These challenges may be particularly pronounced in facilities where the arrangement of gaming tables 10 is periodically altered, or where existing tables 10 are replaced with tables of different sizes, shapes, or configurations. In such circumstances, relocating or remounting cameras 52 may require significant installation effort, disruption of gaming operations, and additional expense associated with rewiring, recalibration, or reconfiguring the surveillance system 50. Accordingly, reliance solely upon physical repositioning of the cameras 52 is often impractical, thereby highlighting a need for alternative techniques to address perspective distortion or skew in captured images and video feeds. Moreover, even if a camera 52 is located directly overhead of a table 10 or layout 12, image distortion can still occur.

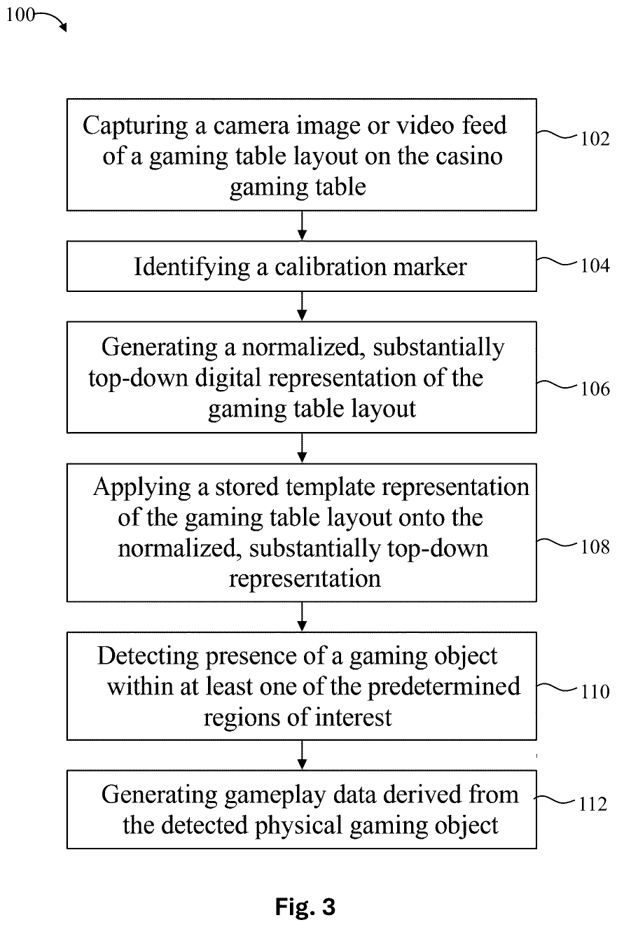

The disclosed system and method 100 are configured to improve monitoring of casino gaming tables. Referring to FIG. 3, the system and method 100 include various steps and elements that are further described with reference to the accompanying figures. It should be understood that one or more of the disclosed steps or elements may be duplicated, omitted, rearranged, divided into multiple steps or elements, combined into a single step or element, or otherwise modified without departing from the scope of the present disclosure.

The method 100 includes a step 102 of capturing a camera image or video feed of a gaming table layout 12 on a casino gaming table 10. The capturing step 102 may be performed using one or more cameras 52. In certain embodiments, the cameras 52 may be arranged at an overhead angle and/or an oblique angle relative to the casino gaming table 10. The one or more cameras 52 may form part of a surveillance or security system 50 mounted to a wall, ceiling, or other support structure. In alternative embodiments, the camera 52 may be a non-surveillance camera integrated into a table sign, an elevated lollipop sign, a chip tray, a card shoe, or other table component. The captured image or video feed is provided to a processing device 58 of the system 100.

In some configurations, the one or more cameras 52 may be arranged overhead of the casino gaming table 10 and not necessarily at an oblique angle. For example, the one or more cameras 52 may be located substantially or directly overhead of the gaming table. In such a configuration, the one or more method steps disclosed herein may still be performed to ensure the one or more images and/or video feed are corrected. For example, ceiling height (low or high) may impact the images and/or video feed that are output from the one or more cameras 52. Therefore, an image or video correction may be made to ensure a correct size and ratio and de-warping of the images and/or video is obtained. Accordingly, the calibration marker disclosed herein may be used to calibrate or obtain properly oriented and sized normalized top down views of the gaming table layout.

The camera 52 may be any image capture device configured to obtain still images or video frames of a casino gaming table or portion thereof. A camera may include, without limitation, digital cameras, analog cameras, charge-coupled device (CCD) cameras, complementary metal- oxide-semiconductor (CMOS) cameras, web cameras, surveillance cameras, or other optical sensor. A camera may capture images in visible light, infrared, ultraviolet, or other spectral ranges, and may optionally include features such as zoom lenses, wide-angle lenses, fisheye lenses, or depth-sensing elements. Cameras may be fixed, movable, or pan-tilt-zoom (PTZ) devices, and may communicate with a processor via wired or wireless connections. The term encompasses both single cameras and systems comprising multiple cameras for capturing different perspectives of the gaming table.

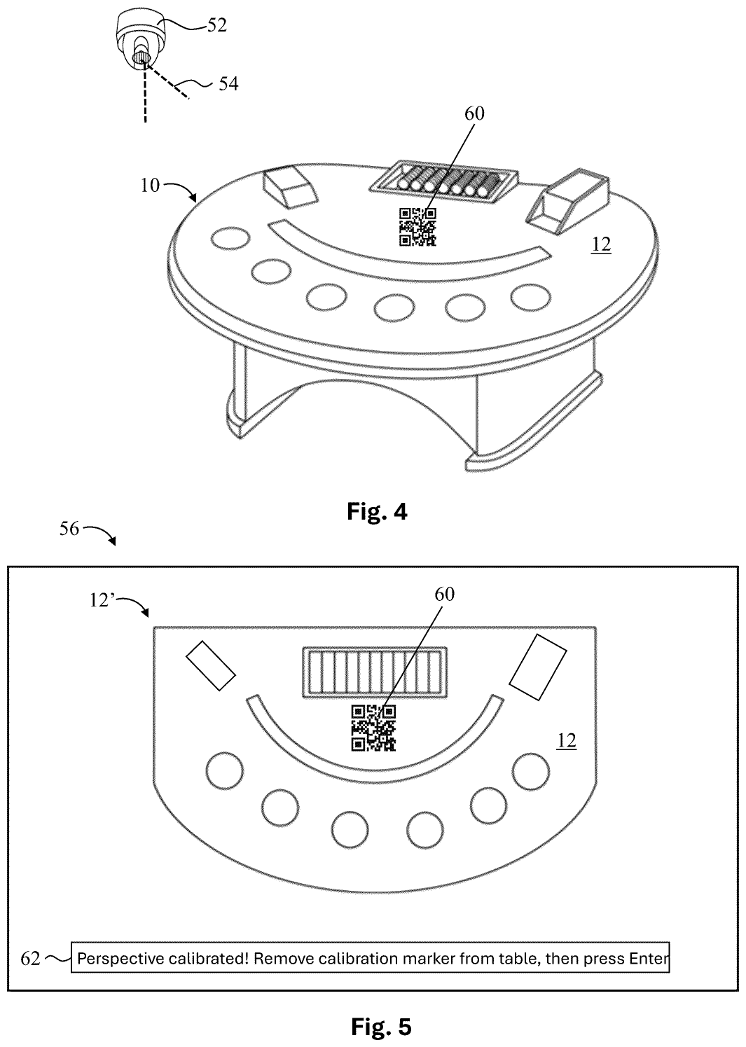

The method 100 includes a step 104 of identifying a calibration marker having a known geometric configuration positioned on the gaming table layout 12 of the casino gaming table 10. For example, referring to FIG. 4, a calibration marker 60 is shown on the gaming table layout 12 and in the line of sight or viewing angle or range 54 of the camera 52. The identifying step 104 may be performed by the processing device 58 using the captured image or video feed, and in certain embodiments may be assisted by functionality of the camera 52.

As used herein, a calibration marker 60 may refer to a visually identifiable feature, symbol, graphic, item, or pattern disposed on or associated with a casino gaming table 10 or layout 12 and having a known geometric configuration. A calibration marker 60 may be a flat 2-dimensional image or a 3-dimensional object. An image calibration device or marker 60 may include one or more known shapes, geometries, sizes, and/or patterns. For example, a calibration marker may include, without limitation, a quick response (QR) code, a barcode, a checkerboard pattern, an array of dots, lines, one or more geometric shapes or patterns, a honeycomb or mesh pattern, or any other machine-readable image feature having a predetermined or known geometry, size, shape, or spatial arrangement. In some configurations, if the table or gaming table layout 12 is already known (i.e., stored in a memory), then the table layout 12 itself may also function as the image calibration device or marker 60 (e.g., the perimeter lines, edges, etc.). The calibration marker 60 may be a physical feature on the table, such as a card shoe, chip tray, discard rack, drop box slot, cube, diamond, prism. The calibration marker 60 may include one or more images or shapes that have a known size and shape. For example, a QR code may be preferred since it includes a variety of different sized square and rectangles.

A calibration marker 60 may be permanently integrated into the gaming table layout 12. A calibration marker 60 may be provided on a card, plaque, sticker, or insert and temporarily placed onto the gaming table layout 12. A calibration marker 60 may be projected onto the gaming table layout 12 by an optical device or light. In some configuration, a calibration marker 60 may be integrated or part of the gaming table layout and is not placed onto the gaming table layout or removed from the gaming table layout. Multiple calibration markers may be used simultaneously to improve accuracy of alignment and transformation. In some configurations, a single calibration marker may be used, but is moved to different areas of the gaming table or table layout during the identifying step. For example, the calibration marker may first be placed at the center of the gaming table and an image or video feed may be collected and corrected. Then the calibration maker may be moved to one or more edges of the gaming table (e.g., dealer area, player area, left side, right side, or any combination thereof) to further correct the image and/or video feed. This may ensure the entire image and/or video feed is corrected for the next steps. If multiple calibration markers were not placed down at different areas of the gaming table, there is a risk that one or more edges or corners of the image or video feed would be warped, skewed, or not in a normalized top down view.

As further described in subsequent steps of the method, the calibration marker 60 may provide one or more reference points that enable the processing device 58 to determine geometric transformations including scaling, rotation, translation, and perspective distortion present in the captured image of the gaming table layout 12. Using these reference points, the processing device 58 generates a normalized, substantially top-down representation of the calibration marker 60. A corresponding conversion may also be applied to the gaming table layout 12 itself, thereby producing a normalized, substantially top-down representation of the gaming table layout 12′.

As used herein, a processing device 58 of the system and method 100 disclosed herein may refer to any hardware, circuitry, or combination of hardware and software configured to execute instructions for performing one or more operations or step of the system or method 100 disclosed herein. A processing device 58 may include, without limitation, a central processing unit (CPU), graphics processing unit (GPU), digital signal processor (DSP), field programmable gate array (FPGA), application-specific integrated circuit (ASIC), neural processing unit (NPU), microcontroller, algorithm, look up table, memory, software, hardware, or any other integrated circuit capable of carrying out image processing and analysis tasks, or any of the other steps disclosed herein, including the transforming of the camera views into the normalized top down views. The processing device 58 may be a stand-alone computing unit, a component of a server, a personal computer, an edge device located near a gaming table, or a cloud-based system communicatively coupled to the cameras. In some embodiments, multiple processing devices may cooperate to share tasks such as image normalization, template application, object detection, machine learning inference, or operator notification.

The processing device 102 may be electrically coupled to one or more cameras 52, to a surveillance system 50, or to an output thereof, and is configured to obtain actual or raw data, images, and/or video feeds of the gaming table layout 12 from the camera 52. As previously noted, when the camera 52 is positioned at an oblique angle rather than directly overhead, the resulting image or video feed of the gaming table layout 12 may be skewed, thereby producing distortions in the appearance of shapes and regions of interest.

The method 100 further includes a step 106 of generating a normalized, substantially top-down representation 12′ of the gaming table layout 12. Step 106 may also include calibrating one or more cameras 52, or calibrating an output from the cameras 52, to obtain the normalized representation. The normalized, substantially top-down representation 12′ may comprise a two-dimensional, bird's-eye view of the gaming table layout 12 that has been straightened, corrected, and undistorted, thereby providing an arrangement that is more readily viewable and analyzable by the system 100. For example, as illustrated in FIG. 2, an actual, raw, or unaltered image or video feed captured by the camera 52 may be provided to the processing device 58, which converts the skewed or distorted image into the normalized, substantially top-down representation 12′ illustrated in FIG. 5.

Step 106 may also be referred to as a transforming step. In this step, the processing device 58 geometrically transforms the captured image(s) or video feed(s) obtained from the one or more cameras 52 based on the calibration marker 60. This means that the normalized, substantially top-down digital representation is or sufficiently corresponds to a corrected version of the actual or raw camera image or video feed. In particular, the processing device 58 is configured to utilize known reference points, data, or pixels associated with the calibration marker 60 to transform the calibration marker 60 and, accordingly, the remainder of the image or video feed into a normalized, substantially top-down representation 12′ of the gaming table layout 12, as illustrated in FIG. 5. The size, shape, image resolution, color, and/or sharpness of the captured image(s) or video feed(s) obtained from the one or more cameras 52 may be transformed into a known standard during the transforming step.

Transformation may be carried out by the processing device 58 calculating a homography matrix, or a similar projective transformation, between points in the actual, raw, or unaltered, angled camera image or video feed and corresponding known points of the calibration marker 60. The corresponding known points may be derived from the calibration marker 60 itself or from another known object disposed on the gaming table 10 or gaming table layout 12.

The processing device 58 may be configured to carry out the identifying steps and the transforming steps. In other configuration, the processing device 58 may be split into two or more devise where one device carries out the identifying step and the other carries out the transforming step. In yet another configuration, the analysis steps disclosed herein may be carried out by the processing device 58, or by a separate processing device. To summarize, one or more of the identifying, transforming, and analysis steps disclosed herein may be executed by a common processing device, or by individual processing devices that are electrically connected together to allow communication therebetween.

Normalization may include applying a homography transformation, perspective correction, warping, rectification, lens undistortion, or lens distortion compensation, based on calibration markers or other reference features present on the table. The result is a digital image in which the spatial arrangement of table elements—such as betting regions, card areas, or dealer zones—appears in their true relative proportions and positions, as if viewed directly overhead.

Substantially top-down” indicates that the representation need not be perfectly perpendicular, but sufficiently close to an overhead view that template images of the gaming table layout can be applied and spatially aligned with functional areas of the table. The representation is “digital” in that it exists as electronic image data processed by a computing or processing device for further analysis.

In one embodiment, the transformation is achieved using a homography matrix, a 3×3 projective transformation computed from reference points of known geometry. Calibration markers—such as QR codes, checkerboards, or fiducial patterns—are placed at known positions on the table surface. The processor detects the markers in the oblique image and establishes point correspondences between the observed marker locations and their true positions in an ideal top-down coordinate system. Using these correspondences, the processor solves for the homography matrix HHH, which defines the mapping between the oblique image and the normalized top-down space. Each pixel in the oblique image is then warped using HHH to generate the normalized representation. The result is a normalized, substantially top-down digital representation in which the gaming table layout appears in its true proportions, enabling accurate overlay of template images, reliable ROI alignment, and precise detection of gaming objects.

The generating or transforming step 106 may include performing a lens distortion correction process. In some embodiments, the lens distortion correction is based on the processing device 58 having stored data or otherwise being configured to recognize the correct (i.e., undistorted) geometry, shape, or pattern of the calibration marker 60, which may also be referred to as an image calibration device. Using this information, the processing device 58 may correct distortions present in the raw images or video feeds captured by the one or more cameras 52 by applying an un-warping or reverse-distortion operation to generate corrected image or video data.

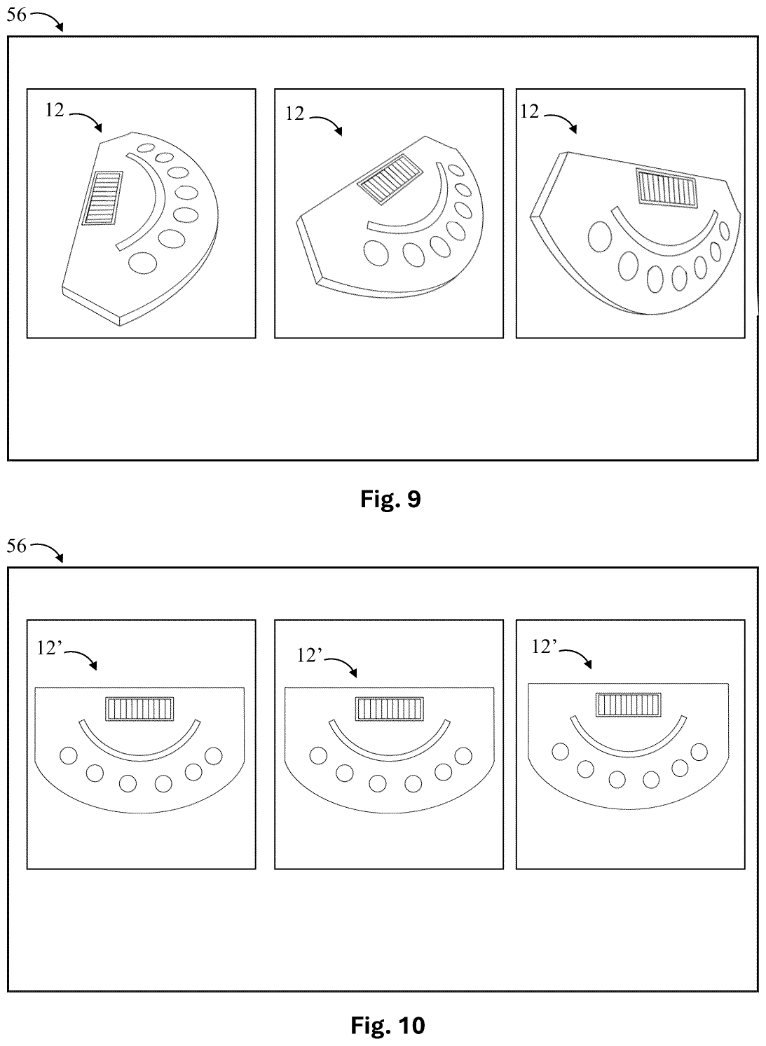

The generating or transforming step 106 may further include adjusting the orientation of the normalized, substantially top-down representation of the gaming table layout 12′ to a predetermined or desired view. In some embodiments, the process may also include cropping unnecessary portions of the image so that only desired areas remain in view. For example, the normalized representation may be rotated by a defined amount such that the resulting corrected image or video feed is oriented in a particular direction (e.g., positioning the chip tray at the 12 o'clock location). Such orientation adjustments can be advantageous when casino personnel or surveillance systems are monitoring multiple casino tables, as consistent alignment facilitates simultaneous review across feeds (see, e.g., FIG. 9, where table images are aligned, in contrast to FIG. 10, where the orientations differ). In addition, the image or video feed may be rotated to a desired position or angle to correspond with, or align to, a stored template representation of the gaming table layout, as described further below.

The generating or transforming step 106 may further include adjusting one or more visual characteristics of the normalized, substantially top-down representation of the gaming table layout 12′. For example, the processing device 58 may enhance brightness, contrast, or sharpness of the image or video feed to improve visibility of gaming objects and table features.

The generating or transforming step 106 may further include adjusting the coloration of the image (i.e., the hue, saturation, and value) to improve discoloration or poor color balance of one or more cameras of the surveillance system. This allows IOIs to appear in their more natural color and will ease monitoring of the image and/or video feed by casino personnel and improve the accuracy and integrity of the system. To reduce discoloration of one or more cameras, the calibration marker may include one or more patterns of a known color(s) (such as a green and black checkerboard pattern). The system may detect the color pattern and calculate the required adjustment in coloration to match the known color. The system may apply these color adjustments to every subsequent incoming frame.

The generating or transforming step 106 may further include performing one or more distortion correction processes, such as barrel distortion correction, pincushion distortion correction, or waveform (mustache) distortion correction, while generating or to generate the normalized, substantially top-down digital representation of the gaming table layout 12. As a result, subsequent still images or video feeds captured by the one or more cameras 52 may be corrected to reduce or eliminate distortion, thereby producing a corrected image or video feed. The corrected image or video feed, or the normalized, substantially top-down digital representation of the gaming table layout 12, may be stored in one or more memory devices for ongoing or future use.

Further adjustment, transformation, or calibration of the normalized, substantially top-down representation of the gaming table layout 12′ may also be performed. For example, to more accurately monitor casino activity within the gaming environment, additional correction of image distortion may be desirable. Image distortion may arise from aberrations or warping introduced by the one or more cameras 52, such as when straight lines in an image appear deformed or unnaturally curved. Distortion may result from curvilinear lenses and can undesirably alter the apparent size or shape of objects, as well as the spacing between them. Such distortion can reduce the accuracy of spatial measurements (e.g., length, area, perimeter, shape, or spacing) and may lead to information loss. Various types of distortion may therefore be corrected or transformed during execution of the method steps described herein.

Image barrel distortion may occur when one or more straight lines may appear to curve outward, resembling a barrel. Barrel distortion may occur when a wide-angle lens is used or when a lens is at full zoom. In barrel distortion, light rays from the edges of the frame are refracted more than those from the center. These distortions may be corrected during one or more steps of the method disclosed herein.

Image pincushion distortion may occur when one or more straight lines appear to be curved inward, resembling the shape of a pincushion. Pincushion distortion may occur in telephoto lenses, where the light rays from the center of the frame are refracted more than those from the edge. These distortions may be corrected during one or more steps of the method disclosed herein.

Image mustache or waveform distortion may be a combination of barrel and pincushion distortion, which includes inward and outward curvature along different sections of straight lines. Mustache or waveform distortion typically occurs in complex lens designs, particularly in certain wide-angle lenses. These distortions may be corrected during one or more steps of the method disclosed herein.

The step of generating the normalized, substantially top-down representation of the gaming table layout 12′ may occur on a frame-by-frame basis for each image and/or on a collection of frames in a video feed.

Once the normalized, substantially top-down digital representation of the gaming table layout 12′ has been obtained or generated, a message or acknowledgement 62 may be displayed on a monitoring device or terminal 56 to confirm successful calibration or completion of the transformation process. Thereafter, if applicable, the calibration marker 60 may be removed from the gaming table 12 so it is not visible or obstruct game play on the table. in other configurations, the calibration marker 60 may remain on the table for the method or processing device to perform ongoing image correction or fine tune the image correction from time to time.

The method step(s) associated with calibrating the one or more cameras or generating the generate the normalized, substantially top-down representation of the gaming table layout 12′ may take place at regularly scheduled time periods, for example: before, during, or after a shift, daily, weekly, monthly, quarterly, semi-annually, annually; when a table layout is changed; when one or more tables in the casino environment are moved, repositioned, changed, or replaced; if the camera view has changed; and/or on an as-needed basis when it is determined that the detection system is not able to accurately provide the images without distortion or distortion within a predetermined tolerance. However, advantageously, if a gaming layout does not change, or if a table is not used, then the one or more stapes associated with calibrating need not be performed on a regular basis. In some configurations, even after a layout change, the one or more cameras need not be calibrated because the calibration may be stored in a database or centralized location or database.

Stated another way, assuming the gaming table and/or cameras are not changed, then the one or more images and/or video feed from the one or more cameras need not be corrected. A correction (e.g., placing calibration marker on table) may need to take place if the distance between the camera and table changes, if the camera is replaced with a different camera, if the casino layout floor changes, etc. Even if a layout changes, the cameras may not need to be calibrated via the calibration marker process.

After the normalized, substantially top-down digital representation of the gaming table layout 12′ is obtained or calculated, a message or acknowledgement 62 may be provided on a monitoring device or terminal 56 that the normalized, substantially top-down representation of the gaming table layout 12′ has been properly obtained, and the system and method 100 can obtain further normalized, substantially top-down digital representations of the gaming table layout 12. If applicable, the calibration marker 60 can be removed from the table.

The method 100 further comprises a step 108 of applying a stored template representation 64 of the gaming table layout onto the normalized, substantially top-down representation 12′ of the gaming table layout. Step 108 may be executed by the processing device 58, which is configured to overlay or align the stored template with the normalized representation.

Before or during the applying step 108, the method 100 may further comprise identifying a matching stored template representation 64 of the gaming table layout from a database or repository containing a plurality of stored template representations. The database or repository may include template layouts corresponding to various table games available at the casino venue or facility. Identification of the matching template may be performed in different ways. In some embodiments, an operator may manually select a template 64 that corresponds to the actual gaming table layout 12. In other embodiments, the processing device 58, alone or in combination with an operator, may retrieve a matching template layout 64 from a local memory, a remote server, or a cloud-based storage system.

The identifying or matching step may be performed by a matching algorithm configured to compare the corrected image or video feed 12′ to a stored template layout 64 with a defined degree of confidence. For example, the matching algorithm may employ image-processing techniques or machine-learning approaches, such as deep learning, to compare one or more regions of interest (e.g., main wager areas or side wager areas) on the stored template 64 to corresponding regions of interest on the corrected, normalized gaming table layout 12′.

The identifying or matching may occur by creating a deep learning model of the template layout 24, or all the gaming table layouts 12 used by the casino, and performing a comparing or matching algorithm. The matching technique may use other matching algorithms such as template matching, feature matching, optical flow matching, etc. or a combination thereof.

The gaming table layout 64 may further include a barcode, QR code, or other machine-readable code or graphic that can be scanned by a scanner associated with the processing device 58 or detected by the one or more cameras 52. After the corrected image or video feed is obtained through the surveillance system, the code appears clear and undistorted, enabling reliable identification. Using the scanned or detected code, the processing device 58 may then retrieve a corresponding stored template layout 64 from the database or repository

After the actual gaming table layout 12 has been identified, additional information associated with that layout may be automatically retrieved from the stored database. Such information may include, for example, the game type, available side wagers, layout verbiage, number of spots, permitted deck sizes, available shuffle methods, gaming items (e.g., chips or dice), and associated pay tables or rules. The retrieved information may then be presented in a variety of ways. In some embodiments, the information may be displayed to casino personnel or patrons (e.g., via table signs), transmitted to a smartphone or other communication device, displayed on a television or other monitor in the vicinity, recorded into a player rating system, or integrated into the analytics system and method according to these teachings for carrying out one or more steps of the method, including the step of generating gameplay data or analytics.

The stored template representation 64 of the gaming table layout may include one or more template regions of interest 66 (see FIG. 6). The processing device 58 may then overlay the stored template 64, including the template regions of interest 66, onto the normalized, substantially top-down representation 12′ of the gaming table layout. In this manner, each predetermined region of interest 66 on the template layout 64 is spatially aligned with a corresponding region of interest in the normalized representation 12′ (see FIG. 7).

Referring to FIG. 7, the stored template representation 64 of the gaming table layout may be overlaid onto, or compared with, the normalized, substantially top-down representation 12′ of the gaming table layout to determine whether a match exists within a defined degree of confidence. If a successful match is established, a message, feedback, or acknowledgement 62 may be provided on the monitoring device or terminal 56. Once matched, the predetermined regions of interest 66 from the stored template representation 64 are overlaid onto the normalized, substantially top-down representation 12′ of the gaming table layout.

The method may further include a step of creating or identifying one or more regions of interest (ROIs) 66 on the stored template representation 64 of the gaming table layout. An ROI may correspond to one or more defined locations on the gaming table layout, such as wager areas (e.g., main wager area, side wager area), card placement areas, chip tray area, card dealing shoe area, discard rack area, shuffler area, dealer work area, player bank area, buy-in area, or money drop box area.

Creating or identifying one or more regions of interest (ROIs) 66 may be accomplished through one or more steps or sub-steps. In some embodiments, the method may begin by obtaining a proof or image of a gaming table layout from a supplier, distributor, printer, or casino. The proof or image may be provided in a variety of formats, such as a digital image file, a printed sheet, or a computer-aided design (CAD) file (e.g., a .STEP file).

Once the proof or image of the gaming table layout has been obtained, the method may include additional steps or sub-steps, such as: manual or automated annotation: drawing circles (colored or wireframe), polygons, or other shapes around the various ROIs to define their boundaries; ROI extraction: obtaining or isolating a single ROI (e.g., a player bet region, which may itself include multiple wagering ROIs), and detecting that ROI within the table layout proof or image using feature mapping, template matching, edge detection, machine learning, or deep learning techniques. Such detection may be enhanced by searching based on known curvature or typical graphical layouts of gaming tables; reference-based estimation: once at least one ROI is detected (for example, a main reference point), the method may estimate the locations of other ROIs based on common curvature and angle of rotation, typical table layouts, or the presence of other known elements (e.g., a chip tray, shoe zone, discard rack, dealer zone, player bank zone, or card placement zone); ROI image extraction and matching: obtaining or extracting images of individual or grouped ROIs, optionally with the background rendered transparent, and then executing a matching algorithm to identify or locate similar outlines on the gaming table layout; ROI similarity detection: obtaining or extracting an image of one ROI and applying a matching algorithm to identify or locate other similar ROI images across the gaming table layout. The image matching and ROI detection may be performed either on the corrected, normalized top-down image or directly on the table layout proof.

The method 100 further comprises a step 110 of detecting the presence of a gaming object within at least one of the predetermined regions of interest (ROIs) 66. Detection may be performed by analyzing a camera feed or image with the processing device 58, which is configured to identify the presence of a gaming object within one or more ROIs defined on the normalized, substantially top-down representation 12′ of the gaming table layout. In some embodiments, the normalized representation 12′ is generated by overlaying the stored template 64, including the ROIs 66, onto the corrected image or video feed.

Prior to or during step 110, the method 100 may further include matching, identifying, or searching within a database or repository containing stored template representations of a plurality of gaming objects. The detected gaming object may then be matched to one or more of the stored template representations. This matching, identifying, or searching may be performed in a manner similar to the process described above with respect to identifying and matching the gaming table layout template 64. In some configurations, the stored template representations of the gaming object may correspond to a stored gaming table layout template or proof 64, such that when the gaming table layout template or proof 64 is identified or matched, the corresponding stored template representations of the gaming object are also automatically identified or matched.

The method 100 further comprises a step of correlating, using the processing device 58, a detected gaming object with a stored template representation of that gaming object. In some embodiments, the processing device 58 may employ one or more machine-learning algorithms, such as deep learning classifiers, trained to improve the accuracy of correlation between the detected gaming object and the stored template representation. For example, if a playing card is detected within a region of interest 66, the processing device 58 may match or correlate the card to a particular value and/or suit based on the applied algorithm. Because the playing card is presented to the processing device 58 in a substantially normalized, top-down view, the correlation may be performed with greater confidence and accuracy than if the card were captured at an oblique angle or in a distorted image. Similar techniques may be applied to other gaming objects, such as currency, gaming chips, coupons, or loyalty cards.

In an embodiment, the correlating step can take place by way of machine or deep learning. In other words, the processing device may know or understand the value or type of the gaming device that is detected based on previous learning or training without having to compare or match with a stored reference. This may reduce the processing requirements of the processing device.

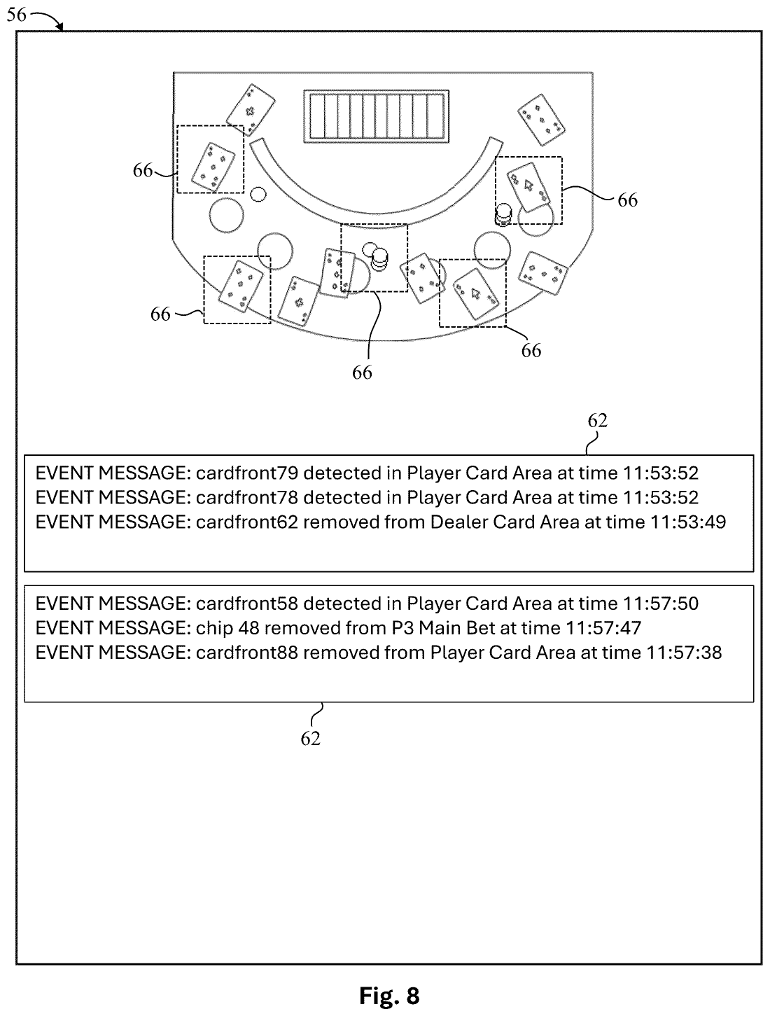

The method 100 further comprises a step 112 of generating, with the processing device 58, gameplay data derived from the detected physical gaming object. The gameplay data may include, for example, a bet amount, the identity of a playing card, a player position, or a payout determination. Referring to FIG. 8, one or more feedback messages or acknowledgements 62 may be generated and presented onto a monitoring device or terminal 56 based on the observations and analytics made by the processing device 58.

The processing device 58 may be configured to carry out the identifying steps, the transforming steps, and the generating steps. In other configuration, the processing device 58 may be split into three or more devices where one device carries out the identifying step another carries out the transforming, and a further processing device carries out the generating step 112. To summarize, one or more of the identifying, transforming, analysis, and generating steps disclosed herein may be executed by a common processing device, or by individual processing devices that are electrically connected together to allow communication therebetween. The processing devices may be located in the cloud, at the gaming facility, or in various locations and connected together via one or more signal or communication protocols.

The processing device 58 may include a machine learning or a Deep Learning Model (DLM) that may be used during one or more of the method steps, including step 112. A machine or deep learning model may be created and/or utilized for each game table layout. For example, one or more DLMs may be utilized to identify stored gaming table template layouts and/or gaming item templates. For example, one or more DLMs may be utilized to generate gameplay data by analyzing activity at the gaming table. The DLM may be trained using simulated events that may occur during actual game play. For example, a model may be trained using simulations of various items of interest (IOIs) located in various regions of interest on the game table layout.

A DLM may be trained to look for various IOIs in certain ROIs when analyzing or observing casino activity taking place on the normalized, substantially top-down representation of the gaming table layout 12′. For example, the DLM may be used to look for and identify playing cards in various ROI player regions; wagering chips in various ROI betting positions; etc. If an item that is not associated with an IOI is detected in one or more of the regions of interest, the processing device may simply ignore the item as it doesn't match a previously identified or learned IOI. For example, if the item is a water bottle in a ROI, then the system process may ignore the water bottle. This may help reduce the amount of information the processing device must process and/or compute.

The DLM method may include a step of obtaining a proof or image of a game table layout (from a supplier, distributor, printer, casino, etc.) This proof or image be an image file, a print, a CAD file (e.g., .step file), etc. This proof or template image may be the same as the gaming table layout 64 discussed above.

The DLM method may include a step of obtaining a template, proof, or image of one or more gaming elements or items of interest (IOI) such as the playing cards (front and back), wagering chips, loyalty cards, currency, dealing shoe, discard racks, cash drop paddle, hands/arms, beverages, detected signage, ash trays, and other items commonly used on casino gaming tables (from a supplier, distributor, printer, casino, etc.) This can be an image file, a CAD file (e.g., .step file), etc. The DLM method may obtain information about one or more hands/appendages. Various hands may be simulated by applying various hand/finger sizes, wrist sizes, skin tone, joints, nails, jewelry, gloves, scars, tattoos, prosthetics or bionic limbs, etc. The hand simulations may be used to simulate different events that may take place (i.e., placing bets, taking winnings, signals to the dealer (hit, stay, double down, split, etc.). Hands/appendages may also be referred to as items of interest (IOI) for purposes of this disclosure. If the model is missing hands/appendages periodically while hands/appendages are being regularly picked up, the system may export images of the missed hands in between successful identification. Such exported images may be sent back to a centralized server and added to the hand model for improvement; Applying the previously identified ROIs onto the game table layout. This may be by importing the ROI file onto the game table layout as an overlay or mask.

After the proofs or image information of the game table layout are obtained, the DLM method may include a step of applying a deep learning algorithm/method to apply the ROI and IOI data/images against or onto the proof or data of the game table layout 64. In this step, the one or more IOIs (such as the cards and chips) are positioned and augmented on the game table layout 12′ in multiple different regions/locations (however may only need to be positioned in the ROIs). Augmentations may include changes to hue, scale, rotation, brightness, contrast, saturation, blur, transparency, percentage of object overlap, etc. Images of the IOIs or gaming elements in these various locations in the ROIs or table layout are stored in a memory (on site, remote location, hard drive, cloud, etc.) and may be used to generate simulated/synthetic images for training the DLM.

Creating a model according to the above steps may be in contrast to doing a live or on-the-fly matching algorithm of cards/chips/gaming elements on the table, which can be negatively affected by other factors like shadows, lights, color fading, buffering, etc. which may undesirably impact the confidence level of the matching/detection.

Additional Items of Interest (IOI), such as a cut card or dealer shoe, can be monitored by the processing device to determine the number of decks on the table. For instance, if the processing device counts roughly 312 cards dealt before identifying the cut card, the processing device may deduce the deck size for the particular game, if the casino sets a deck cutoff size as 2 decks, it is 8 decks. Identifying/detecting the cut card, followed by the removal of the cards from the discard rack, may signify the end of the shoe. The system process may use that point or the removal of the cards from the discard rack as the end of the shoe. Thereafter the counter for the cards will be reset to 0. In the absence of the cut card, cards will be counted until the cards are removed from the discard rack. Removal from the discard rack will reset the card counter to 0.

The one or more cameras or processing device or deep learning model may be configured to detect shuffle methods (an IOI or ROI) by determining the absence of play at the gaming table. Detecting shuffle methods may allow for improved analytics tied to shuffle method. In addition, this will aid the processing device in understanding total card count.

The one or more cameras or processing device or deep learning model may be configured to detect if a chip tray lid is present. Information such as the presence or lack thereof of players or IOI's at the table may indicate the table has changed from open to closed. This state information provides analytic details to casino operators.

The one or more cameras or processing device or deep learning model may be configured to detect the table is open but without players. Player hands/appendages and/or additional IOI's lacking in ROI regions, with the chip tray absent, may indicate the table is open but without players. This information is useful for analytics purposes as well as real time decision making to reduce a limit or potentially close a gaming table or tables.

During operation, if an anomaly or error is detected by the processing device during game play, an indicator may be activated (such an alarm (light and/or audible) to provide notice to casino personnel or pit staff of a malfunction or error.

The linking of rules stated on the layout, and those not stated, are stored with the layout details. These rules have an impact on house advantage thus if the layout for the casino is detected using a particular pay table, or side wager, such house advantage details are accessible to rating system applications. Such rules can be combined with signage rules, which may be preconfigured for the particular game type the layout is associated with, or with the side wager on the layout, to determine a more complete house advantage for the game. Furthermore, applying the house advantage to the player based on the wagering history and betting behavior to build a player profile and/or apply adequate comping based on accurate data. Information on the signage, displayed to the player, might be adjusted to reflect rules and advertisements for a particular game type/rule/side wager/pay table that is detected on the gaming table.

The method 100 may include one or more additional steps. For example, the method 100 may include a verifying step of periodically verifying that the camera image or video feed obtained via the one or more cameras actually corresponds to the stored template representation of the gaming table layout. If it is determined that the camera image or video feed does not correspond to the stored template representation of the gaming table layout, then the method may include a step of performing at least one of: (a) generating a warning or alert; and/or (b) halting game play; and/or (c) searching a repository of stored template representations of gaming table layouts to identify a template representation that corresponds to the camera image or video feed. If the method or system identified a stored layout that matches the actual gaming table layout, then the system or method may alert the casino operators of the successful detection and/or being monitoring the new regions of interest on the new layout.

The method many include a step of suspending generation of gameplay data until a matching stored template representation of the gaming table layout is identified.

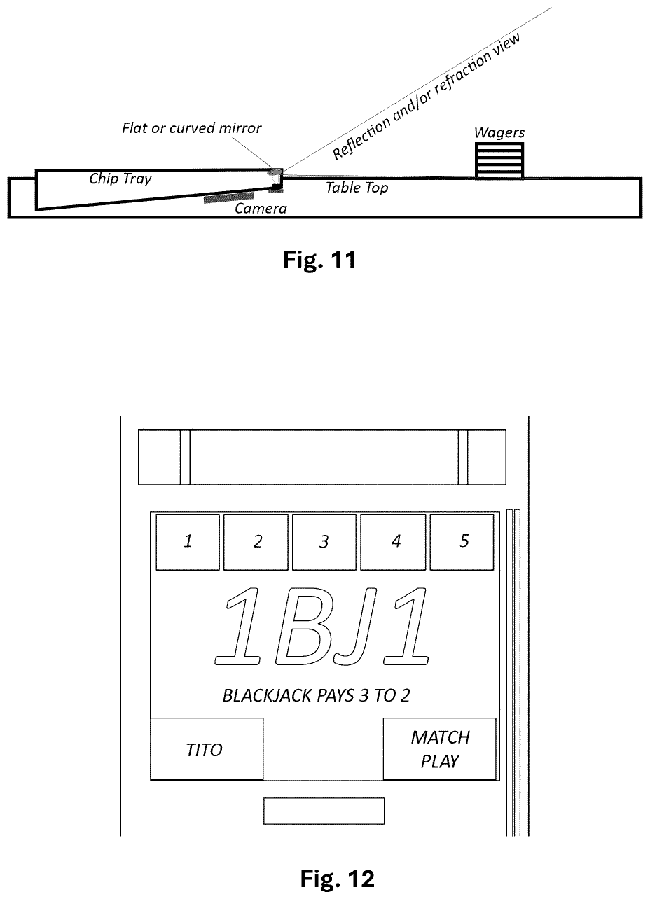

The method 100 may include a step of displaying a plurality of normalized, substantially top-down representations of different gaming tables onto a surveillance terminal 56, wherein each representation is arranged in a consistent orientation for surveillance review. For example, referring to FIGS. 11 and 12.

It is also understood that while a person having skill in the art may identify multiple solutions contained within these teachings, such solutions may be combined into a single system, device, and/or method or may be separated into multiple systems, devices, and/or methods. Accordingly, it is within the scope of these teachings that certain methods and or certain steps disclosed herein may be omitted, duplicated, rearranged into a different order, combined with one or more other methods or steps, incorporated into one or more devices or systems, or any combination thereof.

In some embodiments, the system and method according to these teachings may include one or more steps for identifying or correlating a gaming activity with a particular player. For example, to enable the processing device to identify a player that placed a wager on the game table, the method may include a step of using one or more triangulation techniques between one or more overhead or ceiling camera and one or more table cameras (e.g., located on a table or sign) to identify a player's face.

According to the method disclosed herein, there may be a step where the processing device, via the one or more overhead cameras, identifies an IOI in an ROI (for example, one or more wagering chips (IOI) in a particular bet region associated with a particular player position (ROI)). Using a triangulation analysis, the processing device, by way of the one or more overhead and table cameras, understands that a torso of a player is in a field of view of the gaming table camera, for example at horizontal pixel line 745. The processing device may then request one or more images or a video feed from the one or more table cameras of the player at the particular player position associated with the ROI. The table camera can then provide a generally horizontal image of the player at the player position for the system processor to use facial recognition to identify the player. According to this method, the system processor need not look back in time to review previous image frames or video feed to identify a particular player associated with the gaming activity, the ROI, and/or the IOI. According to this method, the system processor need not look for appendages to trace back to a particular player to identify the player In some embodiments, the system and method according to these teachings may include one or more steps for identifying the amount or value of a wager and at a particular wagering position.

Card and chip recognition may be performed using multiple models operating in parallel. A first model comprises a card value model configured to infer and detect card values directly from an entire image. A second and third model operate in a two-stage pipeline, where the first stage model detects one or more cards and generates cropped card images, and a second stage model processes the cropped card images to determine the corresponding card values. The outputs of the direct card value model and the two-stage card recognition model may be used together to improve accuracy, provide redundancy, and confirm results.

Another approach used is to take a picture of the entire table and then split the table into multiple regions of interest or squares/tables of the required resolution (i.e., 720×720). This could be 15-20 regions of interest for example, and then have high resolution to detect the cards that are in those smaller or secondary ROIs. Potential for one master region of interest determining which sub region to request information from.

For Chip Recognition you can take a picture of the entire table and then split the table into smaller squares/rectangles of the required resolution (i.e., 720×720). This could be 15-20 regions for example, determined by the triangulation between the top down camera and the chip tray camera, or via a calibration process at the chip tray, or using the entire horizontal plane. You then have high resolution to detect the chips that are in those ROIS.

For Chip Recognition, you can acquire the side angle, perspective correct to obtain the corrected perspective image to determine the layout on the table as well as ROI locations, then apply back to the side angle and build the model into the vertical Z-direction to determine the chip height.

For example, to enable the processing device to identify or accurately understand or process a wager (IOI) placed in an ROI, the system or device may include a camera attached to or embedded in the surface of the casino table or layout felt or part of a chip tray or other IOI positioned on the casino table.

In an embodiment, the system or device may optionally include one or more mirrors or reflective surfaces. The one or more mirrors or reflective surfaces may have one or more surfaces that are flat, concave, convex, or a combination thereof. The camera may be positioned at the one or more reflective surfaces so that the camera view is reflected, refracted, and/or redirected from the one or more reflective surfaces in a direction of the one or more chips or IOIs on the casino table or ROIs. The resulting view from the camera can be monitored by the algorithm or system processor to accurately count, monitor, or interpret the amount of chips or wager in an ROI. The sides of the chips may have a different color, texture, or print, which can be distinguished by the camera to further determine the wager amount. An example of the system showing the camera, the reflective surface or mirror, and the view of the reflected, refracted, or redirected view is illustrated in FIG. 11. The one or more mirrors or reflective surfaces may allow for one camera or more than one camera to view a wide angle of the gaming table top thus viewing the gaming chips. The system may utilize a deep learning process to learn chips in chips stacks using real world images and synthetic images designed to account for overlap, shadows, occlusion, wear and tear, and other imperfections not found in a perfect environment.

According to the system and method disclosed herein, the use of one or more triangulation techniques between one or more overhead, table top, or ceiling camera and one or more chip tray cameras (e.g., located on the chip tray, or affixed to an area nearby the chip tray, or a combination of both) to determine which stack resides in what Region of Interest (ROI). For example, the chip tray camera is unable to see the casino layout with enough detail to deduce any information regarding ROI's. For the calibration of the table, utilizing IOI's for each camera and the associated deep learning models, the top down camera detects an IOI A in ROI Player 1 Wager Position 1, the chip tray camera detects IOI A centered at X position 465 (possible pixel count from left to right). The Chip Tray Camera system determine the relative width of the chip to understand depth at that ROI position. This will prevent the system from detecting a wager as opposed to chip possibly stacked further back from position 465. It is possible that the Chip tray camera provides constant output with details regarding chip width, number of chips and their associated metadata (possibly values, colors, versions, etc.) and Position. The overhead camera may deduce this information when it deems relevant based on the gameplay activity.

The processing device may also request images from the Chip Tray Camera for analysis rather than performing the analysis in the vicinity of the chip tray, or a combination may occur.

According to the system and method disclosed herein, the processing device may perform such steps in real time, or possibly accessed stored information regarding wager amounts, locations, etc. for optimal performance.

The device or system according to these teachings may include one or more placards. A placard may be part of or added to a casino table or table layout. Referring to FIG. 12, the placard may include one or more slots for a casino dealer to push currency into during a buy in by a casino patron. The placard contains a touchscreen display and may include one or more player position identifiers associated with each position at the table (in this example 1-5). The player position identifiers may be illuminated different colors to signify an open seat (white), an occupied seat (green), or a closed seat that is not available or one that a patron has just left (red). The identifiers may help with identifying a casino patron as being active at a table or not active. For example, when a new player joins a table, the seat may be active green so the players ranking can run. After the player leaves the table, the dealer may end the player rating. The placard may include one or more code readers or scanners (such a QR or Barcode reader) to scan or read buy in or currency vouchers (commonly referred to as TITO), coupons, loyalty cards, fingerprints, etc. The placard may also allow the dealer to print currency vouchers with an attached printer. Such a printer may print through a slot on the Placard or in a nearby location.

The placard may communicate rules, notes, or comments to a dealer. A dealer may use the placard to signal for assistance from a manager, surveillance, or security.

The placard may be placed anywhere on the table. Preferably, the placard may be placed on the top of the casino table so that a dealer or casino personnel can easily access the placard and/or communicate with the placard with one hand.

The placard may obtain information from the system and method disclosed herein. Information may be communicated to the dealer, for example to apply the calibration marker onto the layout if image calibration is required. The messages or acknowledgement may be provided to the dealer via the placard. The placard may be a monitoring device or terminal according to these teachings.

Various method steps are disclosed herein. It is understood that the steps disclosed or implied herein may be duplicated; merged with one or more other steps; eliminated; moved or rearranged to occur before, during, or after another step; split into two or more sub-steps; or any combination thereof.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

It is within the scope of this disclosure that the teachings herein can be applied to other industries other than casinos, table games, gambling, etc. For example, the use of generating a normalized top down view of activity that is captured by an overhead or obliquely-oriented camera can be applied to other industries such as banking, grocery store checkout lanes, etc. For example, in many industries such as banking, a surveillance network may obtain or monitor multiple image or video streams that are obtained at various angles (See e.g.,. FIG. 9). A human operator or other detection system may have trouble identifying activity taking place in those perspective image or video feeds. Accordingly, the teachings herein may be applied to those image and/or camera streams to obtain normalized top down birds eye views for presenting one or more camera streams at a terminal or display that are from a normalized, top down birds eye view such as in FIG. 10. This may make human and/or machine monitoring or interpretation of the activity easier and more accurate. The normalized top down images may or may not be further analyzed by the system and metho disclosed herein (e.g., machine learning, etc.)

The normalized, substantially top-down digital representation(s) of the gaming table layout(s) may be transmitted to a monitoring device or terminal disposed within a casino surveillance room, a supervisory location, or a pit area proximate to a plurality of gaming tables. Conventional raw or unaltered images or video feeds, such as those illustrated in FIG. 9, may render it difficult for supervisory or surveillance personnel to accurately correlate game play activity across multiple gaming tables due to variations in camera angle, orientation, and perspective. By contrast, presentation of a plurality of normalized, substantially top-down digital representation(s) of the gaming table layout(s) on a common monitoring device or terminal, each consistently oriented in a top-down perspective, is configured to facilitate improved correlation, oversight, and monitoring of gaming activity by casino staff, operators, or surveillance personnel.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor”may include “one or more motors.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. A method for improving monitoring of a casino gaming table, the method comprising:
capturing, with a camera arranged at an overhead position relative to the casino gaming table, an actual camera image or video feed of a gaming table layout on the casino gaming table;
identifying within the camera image or video feed, a calibration marker having a known geometric configuration positioned on the gaming table layout on the casino gaming table;
generating, with a processing device, a normalized, substantially top-down digital representation of the gaming table layout by geometrically transforming the captured image or video feed based on the calibration marker such that the normalized, substantially top-down digital representation corresponds to a corrected version of the actual camera image or video feed;
applying, with the processing device, a stored template representation of the gaming table layout that includes a plurality of pre-determined regions of interest onto the normalized, substantially top-down representation of the gaming table layout such that each of the pre-determined regions of interest is spatially aligned with corresponding locations in the normalized, substantially top-down representation of the gaming table layout;
detecting, from the normalized, substantially top-down representation of the gaming table layout, presence of one or more gaming objects within at least one of the predetermined regions of interest; and
generating, with the processing device, gameplay data derived from the detected one or more physical gaming objects.

2. The method of claim 1, wherein the camera is arranged at an oblique angle relative to the casino gaming table, before the applying step, the method comprises identifying a matching stored template representation of the gaming table layout from a stored repository of a plurality of stored template representations of gaming table layouts.

3. The method of claim 2, wherein the method comprises suspending generation of gameplay data until a matching stored template representation of the gaming table layout is identified.

4. The method according to claim 1, wherein the method comprises
correlating or matching, with the processing device, the detected gaming object with a stored template representation of the gaming object; and
searching a repository comprising one or more stored template representations of a plurality of gaming objects, and matching the detected gaming object with one or more of the stored template representations of the gaming object.

5. The method of claim 1, wherein the method comprises:
periodically verifying that the camera image or video feed corresponds to the stored template representation of the gaming table layout; and
if it is determined that the camera image or video feed does not correspond to the stored template representation of the gaming table layout, performing at least one of:
(a) generating a warning or alert; and/or
(b) halting game play; and/or
(c) searching a repository of stored template representations of gaming table layouts to identify a template representation that corresponds to the camera image or video feed.

6. The method of claim 1, wherein the method comprises displaying a plurality of normalized, substantially top-down representations of different gaming tables onto a surveillance terminal, wherein each representation is arranged in a consistent orientation for surveillance review.

7. The method of claim 1, wherein the method comprises placing the calibration marker onto the gaming table layout, where the calibration marker comprises a QR code or a checkerboard pattern.

8. The method of claim 1, wherein the calibration marker is part of the gaming table layout and is not placed onto the gaming table layout or removed from the gaming table layout.

9. The method of claim 1, wherein the processing device employs one or more machine learning algorithms trained to improve accuracy of correlating the detected gaming object with the stored template representation of the gaming object.

10. The method according to claim 1, wherein the camera comprises an overhead surveillance camera that is part of a casino security system, the surveillance camera operates on a closed network isolated from public access, and the generating step comprises applying a homography transformation.

11. The method according to claim 1, wherein the camera comprises a camera that is located at a table sign or a chip tray.

12. A method for improving monitoring of a casino gaming table, the method comprising:
capturing, with a camera arranged at an overhead position relative to the casino gaming table, an actual camera image or video feed of a gaming table layout on the casino gaming table;
identifying within the camera image or video feed, a calibration marker having a known geometric configuration positioned on the gaming table layout on the casino gaming table; and
generating, with a processing device, a normalized, substantially top-down digital representation of the gaming table layout by geometrically transforming the captured image or video feed based on the calibration marker such that the normalized, substantially top-down digital representation corresponds to a corrected version of the actual camera image or video feed;
communicating the normalized, substantially top-down digital representation of the gaming table layout for viewing or for analyzing gameplay data.

13. The method according to claim 12, wherein the analyzing step comprises applying, with the processing device, a stored template representation of the gaming table layout that includes a plurality of pre-determined regions of interest onto the normalized, substantially top-down representation of the gaming table layout such that each of the pre-determined regions of interest is spatially aligned with corresponding locations in the normalized, substantially top-down representation of the gaming table layout; and
detecting, from the normalized, substantially top-down representation of the gaming table layout, presence of one or more gaming objects within at least one of the predetermined regions of interest.

14. The method according to claim 12, wherein the normalized, substantially top-down digital representation of the gaming table layout is communicated to a monitoring device or terminal that is located at a surveillance room at a casino.

15. The method according to claim 14, wherein a plurality of normalized, substantially top-down digital representations of a plurality of gaming tables are communicated to a monitoring device or terminal that is located at a surveillance room at a casino, wherein the plurality of normalized, substantially top-down digital representations of the plurality of gaming tables as displayed side by side on the monitoring device or terminal.

16. The method according to claim 12, wherein the normalized, substantially top-down digital representation of the gaming table layout is communicated to a monitoring device or terminal that is located in a pit at a casino.

17. A non-transitory computer-readable medium storing instructions that, when executed by one or more processors, cause the one or more processors to perform a method for monitoring a casino gaming table, the method comprising:
capturing, with a camera arranged at an oblique angle relative to the casino gaming table, a raw image or video feed of a gaming table layout including a calibration marker having a predetermined geometric configuration positioned on the gaming table layout;
generating, based on the captured calibration marker, a normalized, substantially top-down digital representation of the gaming table layout from the image or video feed such that the normalized, substantially top-down digital representation corresponds to a corrected version of the raw camera image or video feed; ;
applying a stored template representation of the gaming table layout that defines a plurality of predetermined regions of interest, such that the predetermined regions of interest are spatially aligned with corresponding locations in the normalized digital representation;
detecting presence of a physical gaming object within at least one of the predetermined regions of interest;
correlating the detected physical gaming object with a stored template representation of the gaming object or correlating the detected physical gaming object to an actual gaming object during deep learning or machine learning; and
generating gameplay data derived from the detected physical gaming object.

18. The non-transitory computer-readable medium according to claim 17, wherein the processing device is configured to:
i. search a repository of stored template representations of a plurality of gaming object;
ii. identify a matching stored template representation of the gaming table layout from the stored repository of a plurality of stored template representations of gaming table layouts; and
iii. if it is determined that the camera image or video feed does not correspond to the stored template representation of the gaming table layout, performing at least one of:
a. generate a warning or alert; and/or
b. halt game play; and/or
c. repeat the search.

19. The non-transitory computer-readable medium according to claim 17, wherein the processing device is configured to:
iv. compare the normalized, substantially top-down digital representation of the gaming table layout to the stored template representation of the gaming table layout to determine whether the actual table layout matches the expected layout; and upon determining a mismatch, search a database of table templates including layouts for different casino games to identify a new template image corresponding to the actual table layout; and notify a casino operator or an electronic table sign that the current template does not match the actual table layout.

20. The non-transitory computer-readable medium according to claim 19, wherein the stored template representation of the gaming table layout is applied to the normalized, substantially top-down digital representation of the gaming table layout, as opposed to transforming the stored template representation of the gaming table layout into the image or video feed of the gaming table that is captured with the camera arranged at the oblique angle.
